(19) United States
(12) Patent Application Publication
(10) Pub. No.: US 2020/0093108 A1
(43) Pub. Date: Mar. 26, 2020

(54) Rod Apparatus

(71) Applicant: Concepts Development, LLC, Winchester, VA (US)

(72) Inventor: Ha V. Duong, Winchester, VA (US)

(21) Appl. No.: 16/579,492

(22) Filed: Sep. 23, 2019

Related U.S. Application Data
(60) Provisional application No. 62/735,048, filed on Sep. 22, 2018.
(60) Provisional application No. 62/777,802, filed on Dec. 11, 2018.

(51) Int. Cl. A01K 87/08

(52) U.S. Cl. CPC A01K 87/08

(57) ABSTRACT

An armrest apparatus configured to be mounted on a rod. The armrest apparatus includes an upper armrest unit including an upper armrest bracket and armrest. The apparatus includes a lower armrest unit including a lower armrest bracket configured to attach to the upper armrest bracket to collectively farm a generally cylindrical space. The generally cylindrical space is designed to encircle an outer circumference of the rod. A grip apparatus configured to be mounted on a rod. The grip apparatus includes an upper grip assembly including a grip and a top mounting block. The top mounting block includes a lower bracket and an upper engagement portion. The grip apparatus includes a on grip assembly including a bottom mounting block configured to attach to the top mounting block to collectively form a generally cylindrical space. The generally cylindrical space is designed to encircle an outer circumference of the rod.

### FIELD OF THE INVENTION

The present disclosure relates to new and useful designs for any and all handheld rod structures (reference will be made to fishing rods hereafter, but may also be applied to fishing poles, camera rods, selfie sticks, etc.) in which a grip and/or armrest apparatus is/are removably attached to improve comfort for a user, e.g., fisher nan (gender neutral).

### BACKGROUND OF THE INVENTION

Early fishing poles were made of cane, did not include guides, and a fishing line attached directly to a tip, e.g., no reel. Today, fishing poles typically include a straight rod, guides and a means to attach a reel to the fishing rod. For example, a fisherman holds a fishing pole in his/her hand waiting for a fish to bite. The weight of the pole, sinker, lure or bait, and a fishing line are all exerted on the wrist (e.g., proximal segment of the hand consisting of the carpal bones and the associated soft parts). The wrist, for example, acts as a pivot point and main holding force to prevent the pole from falling into water. And when the fish bite, the wrist acts as the pivot point and at the same time as the main force to pull the fish up before the fisherman can reel it in. This motion is repetitive and stressful to the arm and the wrist, and the larger the catch the larger the stress. To relieve this stress, the fisherman often positions the end of the pole against his/her stomach while pulling and reeling. However, in doing so, the pole is not positioned at the proper angle to reduce or eliminate stress on the wrist and the end of the pole pokes the stomach resulting in additional discomfort and bruising. The new design described herein assists children, disabled, and elderly populations with fishing (and other activities.)

### SUMMARY OF THE INVENTION

One drawback with the conventional design is that it is uncomfortable to hold and use while angling, fishing, jigging, reeling in a fish due in part to the wrist position and repetitive pulling motion required to unsnag the hook (e.g., the fishermen holds the fishing rod in a similar manner as holding a flashlight where the wrist is angled in an awkward and uncomfortable position). In other words, the rod holding method applies stress to the fisherman's wrist and over time will cause joint discomfort and pain around the wrist. The pain factor can be elevated multiple times for fishermen with arthritis and related conditions.

Thus, a need was felt for a fishing rod designed with a grip and/or armrest apparatus designed to attach, individually or collectively, to a fishing rod that reduces or eliminates the aforementioned pain or discomfort by allowing a fisherman to hold the fishing rod in a manner that avoids exerting undue stress on the wrist, which would lead to injury.

According to one aspect of the invention, a grip and/or armrest apparatus are provided that are designed to be mounted on or removably coupled to an outside of a rod.

The armrest apparatus may include an upper portion and a lower portion, Wherein the upper portion includes an armrest attached to an upper side bracket. The upper side bracket is configured to attach to a lower side bracket wherein the upper and lower side brackets collectively wrap around an outer circumference of a handle of the pole.

The grip apparatus may include an upper portion and a lower portion, wherein the upper portion includes a grip attached to an upper side bracket. The upper side bracket is configured to attach to a lower side bracket wherein the upper and lower side brackets collectively wrap around an outer circumference of a handle of the pole. The grip is designed to collapse from a position generally upright to a position generally parallel with the pole (for storage). According to one embodiment, the grip apparatus includes a locking pin and a rotational pin (dowel) configured to allow for the rotation and locking of the grip in a rigid position.

### BRIEF DESCRIPTION OF THE DRAWINGS

The present invention is illustrated by way of example and not limited in the figures of the accompanying drawings in which like references indicate similar elements.

FIG. 1A shows a view of s fishing rod with a grip assembly and armrest assembly attached to the fishing rod according to one embodiment.

FIG. 1B show a view of a fishing rod with a grip assembly and armrest assembly attached to the fishing rod according to one embodiment.

FIG. 2A shows a perspective view of an armrest assembly according to one embodiment.

FIG. 2B shows a top view of the armrest assembly shown in FIG. 2A.

FIG. 2C shows a bottom view of the armrest assembly shown in FIG. 2A,

FIG. 2D shows a right-side view of the armrest assembly shown in FIG. 2A.

FIG. 2E shows a left-side view of the armrest assembly shown in FIG. 2A.

FIG. 3A shows a perspective view of a grip assembly according to one embodiment, wherein the grip assembly is in a first position.

FIG. 3B shows a front view of the grip assembly shown in FIG. 3A.

FIG. 3C shows a rear view of the grip assembly shown in FIG. 3A.

FIG. 3D shows a left-side view of the grip assembly shown in FIG. 3A.

FIG. 3E shows aright-side view of the grip assembly shown in FIG. 3A.

FIG. 4A shows a perspective view of the grip assembly shown in FIG. 3A in a second position.

FIG. 4B shows a left-side view of the grip assembly shown in FIG. 4A.

FIG. 4C shows a right-side view of the grip assembly shown in FIG. 4A.

FIG. 5 shows a grip sub-assembly according to one embodiment.

FIG. 6 shows a grip according to another embodiment.

FIG. 7 shows a disassembled lower bracket and bottom mounting block according to one embodiment.

FIG. 8A shows engagement between upper walls of top mounting block and grip in a first position according to one embodiment.

FIG. 8B shows engagement between upper walls of top mounting block and grip in a second position according to one embodiment.

FIG. 9 shows a perspective view of a second embodiment of a grip assembly.

FIG. 10 shows a perspective view of a third embodiment of a grip assembly.

### DETAILED DESCRIPTION

Reference will now be made to the exemplary embodiments illustrated in the drawings, and specific language will be used here to describe the same. It will nevertheless be understood that no limitation of the scope of the invention is thereby intended. Alterations and further modifications of the inventive features illustrated here, and additional applications of the principles of the inventions as illustrated here, which would occur to a person skilled in the relevant art and having possession of this disclosure, are to be considered within the scope of the invention.

As used herein, various singular forms “a,” “an” and “the” are intended to include various plural forms as well, unless context clearly indicates otherwise. For example, a term “a” or “an” shall mean “one or more,” even though a phrase “one or more” is also used herein. Use of the optional plural “(s),” “(es),” or “(ies)” means that one or more of the indicated features is present.

As used herein, a term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, features described with respect to certain embodiments may be combined in or with various other embodiments in any permutational or combinatory manner. Different aspects or elements of example embodiments, as disclosed herein, may be combined in a similar manner.

Various terminology used herein can imply direct or indirect, full or partial, temporary or permanent, action or inaction. For example, when an element is referred to as being “on,” “connected” or “coupled” to another element, then the element can be directly on, connected or coupled to the other element or intervening elements can be present, including indirect or direct variants. In contrast, when an element is referred to as being “directly connected” or “directly coupled” to another element, there are no intervening elements present.

The term “geometrically-shaped” as used herein includes circular, polygon, rectangular, square, and triangular shapes.

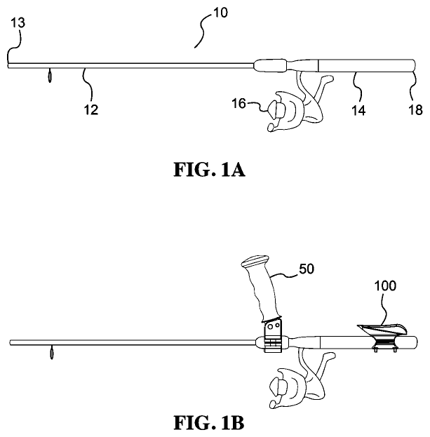

FIG. 1A shows a view of a conventional fishing rod 10 without a grip assembly and armrest assembly attached to the fishing rod. The fishing rod 10 includes a rod 12, handle 14, reel 16, and butt rest 18 opposite a tip end 13 of the rod 12. FIG. 1B shows the fishing rod 10 with a grip assembly 50 and armrest assembly 100 attached to a handle 14 the fishing rod 10 according to one embodiment of the invention. The fishing rod 10 includes a rod 12, handle 14, reel 16, and butt rest 18 opposite a tip end 13 of the rod 12.

The armrest assembly 100, described in greater detail below, is configured to provide support to a fisherman's (gender neutral) forearm 20 and designed with to line up the fisherman's forearm and wrist in natural position and to use the forearm as a main point of exertion force. Accordingly, during fishing operation, when fish bite, a pulling force isn't generated by the wrist. Instead, the wrist 22 acts as a pivot point, and most or all the pulling force is generated by the forearm.

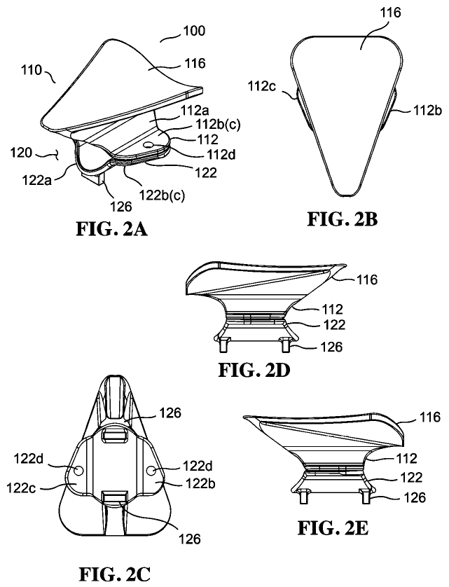

FIGS. 2A-E show a perspective, top, bottom, right-side, and left-side view, respectively, of one embodiment of the armrest assembly 100.

The armrest assembly 100 comprises upper armrest unit 110 and lower armrest unit 120. The upper armrest unit 110 and lower armrest unit 120 may be two separate components attached to each other or integrated into one component. The illustrations below show an embodiment in which the armrest assembly 100 comprises separate components 110 and 120 (e.g., cost efficient manufacturing advantage). The armrest assembly 100 may be formed of plastic, metal, or a combination thereof.

The upper armrest unit shown in FIGS. 2A-E includes an upper armrest bracket 112 and armrest (receiving unit) 116. The lower armrest unit comprises a lower armrest bracket 122 configured to attach to the upper armrest bracket 112 to form a cylindrical space having the same general diameter as an outer diameter of the handle 14 of the fishing rod 10 so that the armrest assembly can be mounted on an outside of the handle 14.

The upper armrest bracket 112 shown in FIGS. 2A-E includes central portion 112a and flange portions 112a, 112b extending outward from the central portion 112a. The flange portions 112b, 112c include apertures 112d configured to receive a fastening unit 40, e.g., screw and nut, etc. The central portion 112a is curved outward with respect to the flange portions 112b, 112c to form a general half-circle shape.

The lower armrest bracket 122 shown in FIGS. 2A-E includes central portion 122a and flange portions 122b, 122c extending outward from the central portion 122a. The flange portions 122b, 122c include apertures 122d configured to receive a fastening unit 40, e.g., screw, bolt, etc. The central portion 122a is curved outward with respect to the flange portions 122b, 122c to form a general half-circle shape.

The lower armrest bracket 122 may include an arm strap retainer 126 extending downward from a bottom side of the bracket 122. The arm strap retainer 126 is configured to accommodate an arm strap or fishing belt (not shown) (e.g., for users that carry the fishing rod 10 over their arm). The arm strap retainer may include a set of wall portions (retainer walls).

The upper armrest bracket aperture 112d is designed to match-up with the lower armrest bracket aperture 122d when the upper armrest bracket 112 is positioned against the lower armrest bracket 122 in a manner such that the central portions 112a and 122a collectively form a generally cylindrical space. The cylindrical space is designed to wrap around and accommodate the handle 14 of the fishing rod 10. The brackets 112 and 122 are attached by clamping down together by inserting the fastening unit 40 through the apertures 112d and 122d and securing the fastening unit 40 in place (e.g., nut and bolt).

The armrest 116 is located on an upper portion of the upper bracket 112, e.g., extends away from an upper portion of the central portion 115 of the upper bracket 112 via a protrusion. In this embodiment, the armrest 116 is generally concave (to generally correspond to a fisherman's forearm shape and increase comfort) and declines downward (e.g., 10-20 degrees), from back to front of the armrest 116, towards the handle 14.

The armrest 116 may include a rubber pad or wrap (not shown) around its upper most surface for additional comfort. Rubber material may also be added to the inside circular surfaces of both the armrest and the bracket to provide additional friction between the apparatus and the pole's handle for better rigidity. Other known materials that provide additional friction may also be used. The armrest 116 may be a separate component or formed integral with the upper armrest bracket 112 as a unitary component. The embodiment shown in FIGS. 2A-E show an embodiment in which the armrest 116 is formed integral with the upper armrest bracket 112 as a unitary component.

The armrest assembly 100 is configured move along the length of the handle 14 and can rotate around the pole's diameter to accommodate different arm lengths, sizes and most comfortable angle as user desires. Once the armrest apparatus 100 is properly adjusted in the desired location and angle, it can be securely tightened to the pole's handle 14 via the fastening elements 40 as described above.

In another embodiment, the upper and lower armrest brackets 112 and 122 of the armrest assembly 100 can include snaps (e g., instead of apertures and fastening elements) designed to snap together for ease of assembling and removal for storage.

In other embodiments, the upper and. lower armrest brackets 112 and 122 can be configured to connect to each other by elastic material (e.g., tie wrap) or adhesive (e.g., tape or glue).

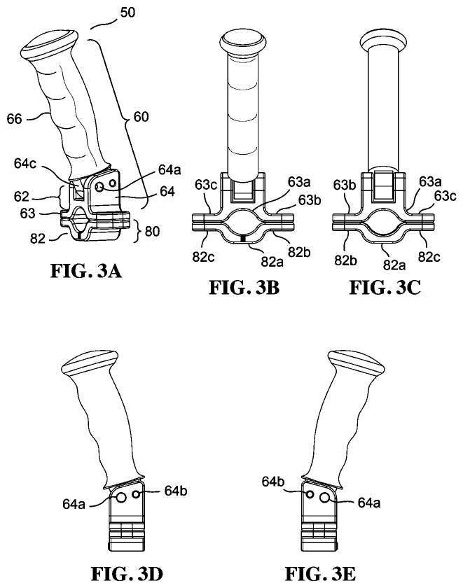

FIGS. 3A-E show a perspective, front, rear, right-side, and left-side view, respectively, of one embodiment of grip assembly 50, wherein a grip 66 of the grip assembly 50 is in a first position. The first position is the open or use .position wherein the grip 66 is positioned generally upright (e.g., 10-20 degrees, more preferably 13-17 degrees, most preferably 15 degrees from vertical) with respect to the lengthwise direction of the handle 14. As described below, the grip 66 is designed to lean forward to generally match a user's natural arm/palm position when handling the fishing rod 10, e.g., 13-17 degrees from vertical, preferably 15 degrees.

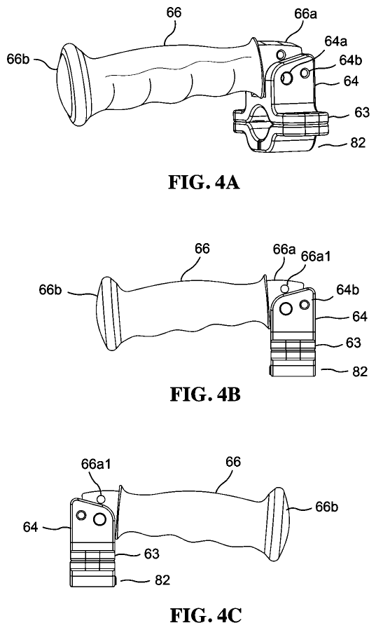

FIGS. 4A-C show a perspective, left-side, and right-side view, respectively, of the grip assembly 50 shown in FIGS. 3A-E, wherein the grip 66 of the grip assembly 50 is in a second position. The second position is a closed or non-use position wherein the grip 66 is positioned generally parallel with the lengthwise direction of the handle 14.

The components of the grip assembly 50 may be formed of plastic, metal, rubber, or a combination thereof. The grip assembly 50 and armrest assembly 100 (described above) may be two separate components or integrated into one component. The grip assembly 50 and armrest assembly 100 may be used individually or collectively with a fishing rod 10. The illustrations below show an embodiment in which the grip assembly 50 and armrest assembly 100 are separate components (e.g., cost effective manufacturing advantage).

The grip assembly 50 is configured to be mounted to the handle 14 of the fishing rod 10 in several locations, including directly above the reel 16, in front of the reel 16, or behind the reel 16. The grip assembly 50 is located closer to the tip end of the fishing rod 10 than the armrest assembly 100.

In the embodiment shown in FIGS. 3A-E and 4A-C, the grip is designed to collapse or fold down (from the first position to the second position). One advantage of this collapsible design is space saving, namely that the collapsed grip occupies less space (e.g., makes it easier for transport and storage and reduces entanglements with other fishing gears or accessories).

The grip assembly 50 comprises upper grip assembly 60 and lower grip assembly 80. The upper grip assembly 60 and lower grip assembly 80 may be two separate components attached to each other or integrated into one component. The illustrations below show an embodiment in which the grip assembly 50 comprises separate components 60 and 80 (e.g., cost efficient manufacturing advantage).

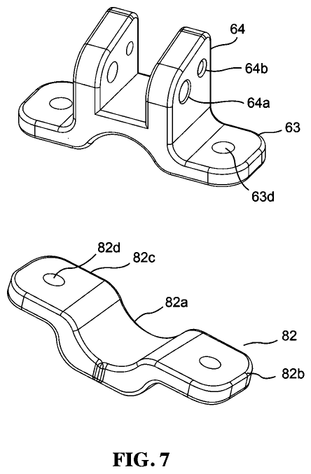

As shown in FIG. 7, the upper grip assembly 60 comprises the grip 66 and a top mounting block 62 configured to attach to a bottom mounting block 82 of the lower grip assembly 80. The top mounting block 62 comprises a lower bracket 63 and an upper engagement portion (e.g., upper walls 64), formed as a single until or attached to one another. In the embodiment shown, these elements are formed as a single unit. The upper engagement portion comprises a pair of spaced apart upper walls 64 that extend vertical from a top of the lower bracket 63. Each of the upper walls 64 includes at least one aperture 64a formed therein and configured to receive a rotational shaft 73 (e.g., dowel pin), described below. A space 64c formed between the upper walls 64 is configured to accommodate an engagement portion 66a of the grip 66. Each of the upper walls 64 may also include a second opening 64b. The second opening is configured to receive a locking pin for securing the grip 66 in desired location, described below

The lower bracket 63 is configured to attach to the bottom mounting block 82 to form a cylindrical space having the same general diameter as an outer diameter of the handle 14 of the fishing rod so that the grip assembly 50 can be mounted on the outside of the handle 14.

The lower bracket 63 includes a central portion 63a and flange portions 63b, 63c extending outward from both sides of the central portion 63a. The flange portions 63b, 63c include apertures 63d configured to receive a fastening unit 40, e.g., screw and nut, etc. The central portion 63a is curved outward with respect to the flange portions 63b, 63c to form a general half-circle shape.

The bottom mounting block 82 includes central portion 82a and flange portions 82b, 82c extending outward from both sides of the central portion 82a. The flange portions 82b, 82c include apertures 82d configured to receive a fastening unit 40, e.g., screw and nut, etc. The central portion 82a is curved outward with respect to the flange portions 82b, 82c to form a general half-circle shape.

The lower bracket 63 is designed to match-up with the bottom mounting block 82 when the lower bracket 63 is positioned against the bottom mounting block 82 in a manner such that the central portions 63a and 82a collectively form a generally circular or cylindrical space. The cylindrical space is designed to wrap around and accommodate the handle 14 of the fishing rod 10. The lower bracket 63 is attached to the bottom mounting block 8s by clamping down together by inserting the fastening unit 40 through the apertures 63d and 82d and securing the fastening unit 40 in place (e.g., nut and bolt).

The grip assembly 50 is configured move along the length of the handle 14 and can rotate around the pole's diameter to accommodate different arm lengths, sizes and most comfortable angle as user desires. Once the apparatus is properly adjusted in the desired location and angle, it can be securely tightened to the pole's handle via the fastening elements 40 as described above.

In another embodiment, the lower bracket 63 and bottom mounting block 82 can include snaps (e.g., instead of apertures and fastening elements) designed to snap together for ease of assembling and removal for storage.

In other embodiments, the lower bracket 63 and bottom mounting block 82 can be configured to connect to each other by elastic material (e.g., tie wrap) or adhesive (e.g., tape or glue).

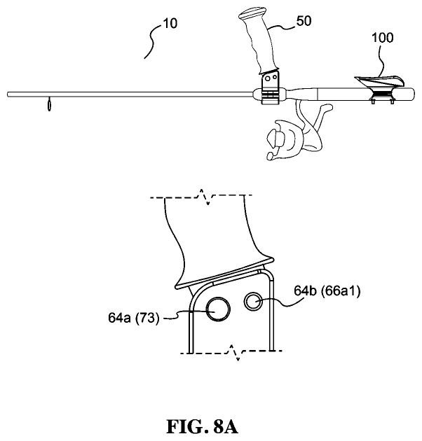

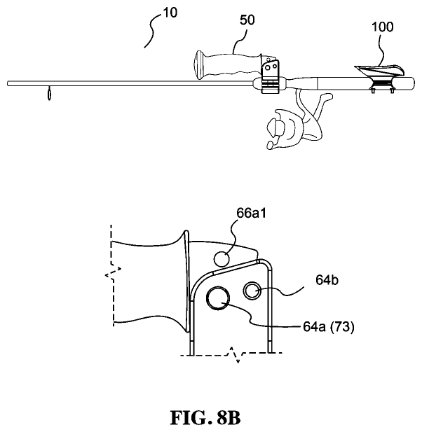

The grip includes a grip portion 66, end 66b and engagement portion 66a. The engagement portion 66a is arranged on the top mounting block 62 side and arranged in an assembled state in the space 64c formed between the upper walls 64. The engagement portion 66a is formed with aperture 66a1 configured to line up with aperture 64b in the second position (and not in the first position) and aperture 66a2 configured to line up with aperture 64a in first and second positions. See FIGS. 8A, 8B. The lined-up apertures 66a1 and 64a are configured to accommodate insertion and securement of a rod or pin (e.g., dowel) to allow rotation of the grip 66 from the first position not the second position (e.g., vertical position to use and horizontal position to store). The lined-up apertures 66a2 and 64b are configured to accommodate insertion of a lock pin to hold the grip 66 in place.

The top mounting bracket 62 may also include a detail portion (e.g., “Stop Wall”) designed to engage with a lower back side of the grip 66 when the grip 66 is in upright position to prevent the grip 66 from bending backward (e.g., away from the tip end of the fishing rod).

The top mounting bracket 62 and the bottom mounting block 82 can be formed of metal to improve strength, however, they may be made of other materials, including plastic.

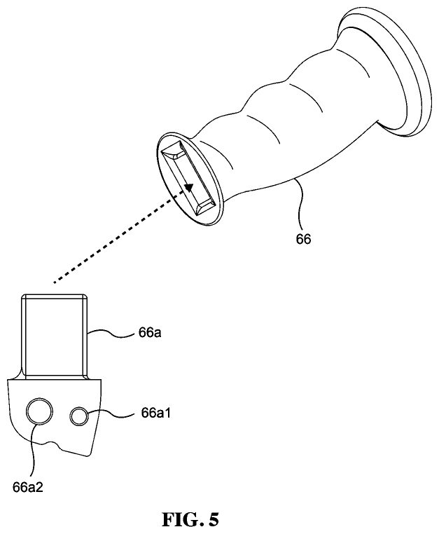

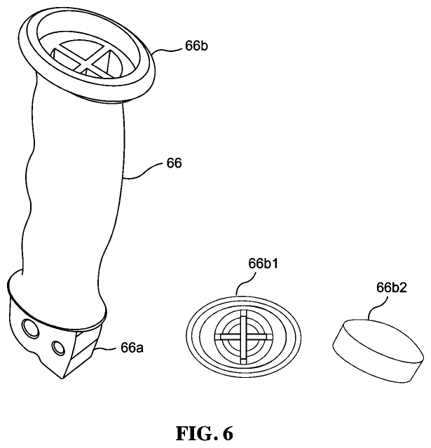

As shown in FIG. 5, the engagement portion 66a may be a separate component (and material) from the grip 66 and designed to be partially inserted into a receiving space formed inside a lower end of the grip 66a. In this embodiment, the portion of the engagement portion 66a positioned outside the grip 66 is positioned in an assembled state in the space 64c formed between the upper walls 64. The grip 66 may be formed hollow to reduce weight and material costs. As shown in FIG. 6, the end 66b of the grip 66 may include a cap 66b2 (removable) if the grip 66 is formed as a hollow unit.

In one embodiment, the grip and the armrest are installed and used as a set. However, it's possible that either assembly can be used separately due to benefits each assembly provides individually.

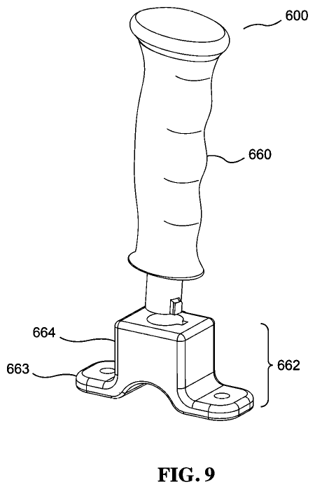

As shown in FIG. 9, a grip apparatus 600 may be designed with a lock-and-twist feature in order to secure the grip 660 to amounting bracket 662 and eliminate one or more of a locking pin and dowel pin structure. In this embodiment, the top mounting bracket 662 is configured to receive a locking tab/protrusion formed on an engagement portion of the grip 660. The top mounting bracket 662 would include a lower bracket 663 designed to match with a bottom bracket (not shown) to allow for mounting the grip apparatus 600 on the handle 14 of the pole 10.

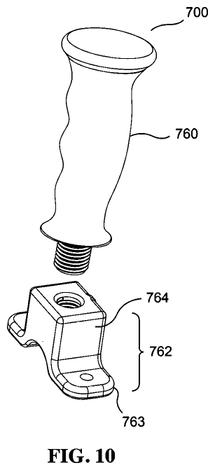

As shown in FIG. 10, a grip apparatus 700 may be designed with a screw in order to secure the grip 760 to the mounting bracket 762 and eliminate one or more of a locking pin and dowel pin structure. In this embodiment, the top mounting bracket 762 is configured to receive a male thread formed on an engagement portion of the grip 760. The top mounting bracket receiving portion is formed with matching threads. The top mounting bracket 762 would include a lower bracket 763 designed to match with a bottom bracket (not shown) to allow for mounting the grip apparatus 700 on the handle 14 of the pole 10.

In another embodiment, the grip 66 and the mounting bracket 62 could be formed into a single piece in order to reduce the number of components.

The above-described grip assembly 50, 600 and 700 and armrest assembly 100 are configured to be removably coupled to various rods. For example, a user can use the same assembly on different rods.

Another embodiment includes a method for attaching or securing the above-described grip assembly 50, 600, 700 and armrest assembly 100 to a handle 14 of a rod, namely a fishing rod. According to this embodiment, the user would attach or secure the grip assembly 50, 600, 700 to the rod and then attach or secure the armrest assembly 100 to a portion of the handle 14 further away from the tip end of the rod than the grip assembly 50, 600, 700. However, it is understood that there is no preferred order to the method of attachment or securement.

The above-described invention has a number of particular features that should preferably be employed in combination, although each is useful separately without departure from the scope of the invention. While the preferred embodiments of the present invention are shown and described herein, it will be understood that the invention may be embodied otherwise than herein specifically illustrated or described, and that certain changes in form and arrangement of parts and the specific manner of practicing the invention may be made within the underlying idea or principles of the invention.

The above-described invention has a number of particular features that should preferably be employed in combination, although each is useful separately without departure from the scope of the invention. While the preferred embodiments of the present invention are shown and described herein, it will be understood that the invention may be embodied otherwise than herein specifically illustrated or described, and that certain changes in form and arrangement of parts and the specific manner of practicing the invention may be made within the underlying idea or principles of the invention.

Although the invention is described herein with reference to specific embodiments, it is understood that various modifications and changes can be made without departing from the scope of the present invention.

I claim:

1. An armrest apparatus configured to be mounted on a rod, the apparatus comprising:
an upper armrest unit comprising an upper armrest bracket and armrest, the armrest located on an upper portion of the upper bracket; and
a lower armrest unit comprising a lower armrest bracket configured to attach to the upper armrest bracket to collectively form a generally cylindrical space, wherein
the generally cylindrical space is designed to encircle an outer circumference of said rod.

2. A grip apparatus configured to be mounted on a rod, the apparatus comprising:
an upper grip assembly comprising a grip and a top mounting block, the top mounting block comprising a lower bracket and an upper engagement portion;
a lower grip assembly comprising a bottom mounting block configured to attach to the top mounting block to collectively form a generally cylindrical space, wherein
the generally cylindrical space is designed to encircle an outer circumference of said rod.

3. The grip apparatus of claim 2 wherein
the grip comprises a grip portion and an engagement portion,
the engagement portion is configured to cooperate with the top mounting block and enable the grip to move from a first position to a second position.
